(19) United States
(12) Patent Application Publication
(10) Pub. No.: US 2012/0220164 A1
(43) Pub. Date: Aug. 30, 2012

(54) PORTABLE AC OUTLET BOX FOR SERVICE PERSONNEL, AND METHOD

(76) Inventor: Jason Flynn, Farmingville, NY (US)

(21) Appl. No.: 13/403,134

(22) Filed: Feb. 23, 2012

Related U.S. Application Data
(60) Provisional application No. 61/463,999, filed on Feb. 24, 2011.

(51) Int. Cl. H01R 13/66; B23P 17/00

(52) U.S. Cl. 439/535; 29/402.01

(57) ABSTRACT

A portable outlet box encompasses an electrical box housing an AC outlet with a short flexible three conductor electrical cord emanating from it. The electrical cord has the outer covering stripped away from the end revealing a white, a black, and a green insulated pigtail, each terminated in an insulating boot covering a connector spring clip. The clips for the white (neutral) and black (hot) pigtails are larger general purpose clips, while the clip attached to the green (ground) pigtail is a smaller boot-covered alligator clip to emphasize that it is different from the other two. The pigtails are electrically clipped to terminals of the unit being serviced. The electrical box has attached flat ceramic magnets on the back side to permit removably mounting it to any ferromagnetic surface. Preferably, the outlet is supplied through an integral GFI interrupter for safety.

### RELATED APPLICATIONS

This application claims benefit and priority of provisional application Ser. No. 61/463,999 filed on Feb. 24, 2011 under 35 U.S.C. §119(e), which application is incorporated by reference herein.

### FIELD OF THE INVENTION

The present invention relates to a portable AC power box which connects to the AC power of a device being repaired at a remote location, such as on top of a rooftop or at another outdoor work site not conveniently located near the vicinity of an AC power source plug receptacle.

### BACKGROUND OF THE INVENTION

People who service outdoor equipment, especially on rooftops or other remote locations, often have a need for utility power for their service equipment. The equipment being serviced almost invariably has the required voltage (eg. −110VAC) but lacks a convenience outlet to permit the service equipment to be plugged in. Long extension cords or portable generators have been used to power the service equipment in these situations.

Although the prior art does show purpose-designed power outlet strips and similar devices, they are invariably provided with an electrical plug on an extension cord to supply power to the outlets. An example of such devices is U.S. Pat. No. 7,815,332 of Smith which shows an under-cabinet box with light source, power outlets and ground fault interrupter (GFI) built in.

### OBJECTS OF THE INVENTION

It is therefore an object of the present invention to provide a portable AC power box which connects to the AC power of a device being repaired at a remote location, such as on a rooftop or at another outdoor work site not conveniently located near the vicinity of an AC power source plug receptacle.

It is also an object of the present invention to provide a portable AC power box which utilizes the power of a device being repaired and which promotes access to AC power at remote work site locations.

Other objects which become apparent from the following description of the present invention.

### SUMMARY OF THE INVENTION

The portable outlet box of this invention comprises an electrical box housing an AC outlet with a short flexible three conductor electrical cord emanating from it. The electrical cord has the outer covering stripped away about eight inches from the end revealing a white, a black, and a green insulated pigtail each terminated in an insulating boot covering a connector spring clip. The clips for the white (neutral) and black (hot) pigtails are larger general purpose clips, while the clip attached to the green (ground) pigtail is a smaller boot-covered alligator clip to emphasize that it is different from the other two. The electrical box has attached flat ceramic magnets on the back side to permit removably mounting it to any ferromagnetic surface. Preferably, the outlet is supplied through an integral GFI interrupter for safety.

Consider a typical application wherein a professional service person is called to service a rooftop air conditioning (AC) unit that was empty of refrigerant and the lines needed to be vacuumed out. He or she would carry a vacuum pump to the roof along with the portable outlet box of this invention. The electrical connection box or panel on the rooftop AC is opened, and the AC power terminals are located. Then the portable outlet box is preferably attached to the housing of the AC unit at a close convenient location via the magnets on the back. (It is important to relieve pigtails of any stress by attaching the box securely to prevent any device/plug from pulling off the connections from the terminals.) The three clips on the pigtails of the portable box are then connected to the appropriate terminals. Then the vacuum pump is simply plugged in to the outlet on the front surface of the portable box. This direct time-saving procedure contrasts with the alternatives. Even if it were simple to use an available outlet with a long extension cord, the service person would typically spend time looking for it. Then there would be more time spent laying out a heavy extension cord, and then rolling it back up after the service. If the extension cord option is not feasible, the other alternative is to lug a portable gasoline-powered generator to the rooftop, start it with a pull cord, and hope it is reliable!

In the first embodiment, readily available components are used to fabricate a very rugged portable AC outlet box. A standard square 4″ metal electrical box is used as the housing. A standard single duplex front panel is used to attach a GFI single outlet (with optional on/off switch). A standard metal strain relief is used to engage the electrical cord mechanically to the electrical box. Several disk magnets are adhesively bonded to the back side of the electrical box.

In the preferred embodiment, a purpose-designed plastic housing and front panel are used. Preferably, although other plastics may be used, a rigid thermoplastic, such as acrylonitrile-butadine-styrene (ABS) plastic, with a rubberized outer covering, is used to enhance the tactile feel and offer attractive logo options. The housing is rendered water resistant by using an elastomeric gasket between front panel and housing and between GFI/outlet module and front panel. An optional swinging transparent (preferable UV-resistant polycarbonate) panel covers the front panel as a rain shield. The strain relief for the electrical cord is an elastomeric waterproof variety. A hydrophobic vent to keep the interior dry is also recommended. Magnets are preferably attached to the back surface to permit attachment to any ferromagnetic surface such as an equipment housing or support structure.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective view of the first embodiment (using a metal housing) of a portable outlet box of this invention.

FIG. 2 is a back elevation showing several round ceramic magnets attached to the back side of the housing.

FIG. 3 is a perspective view of the preferred embodiment (using a plastic housing) portable outlet box showing several of the distinguishing features.

FIGS. 4A and 4B are schematic representations of prior art use of an extension cord in FIG. 4A and a generator in FIG. 4B.

FIG. 4C is a schematic representation of the method used in applying the portable outlet box of this invention to a service call; it is contrasted with two prior-art methods in prior art FIGS. 4A and 4B

### DETAILED DESCRIPTION OF THE INVENTION

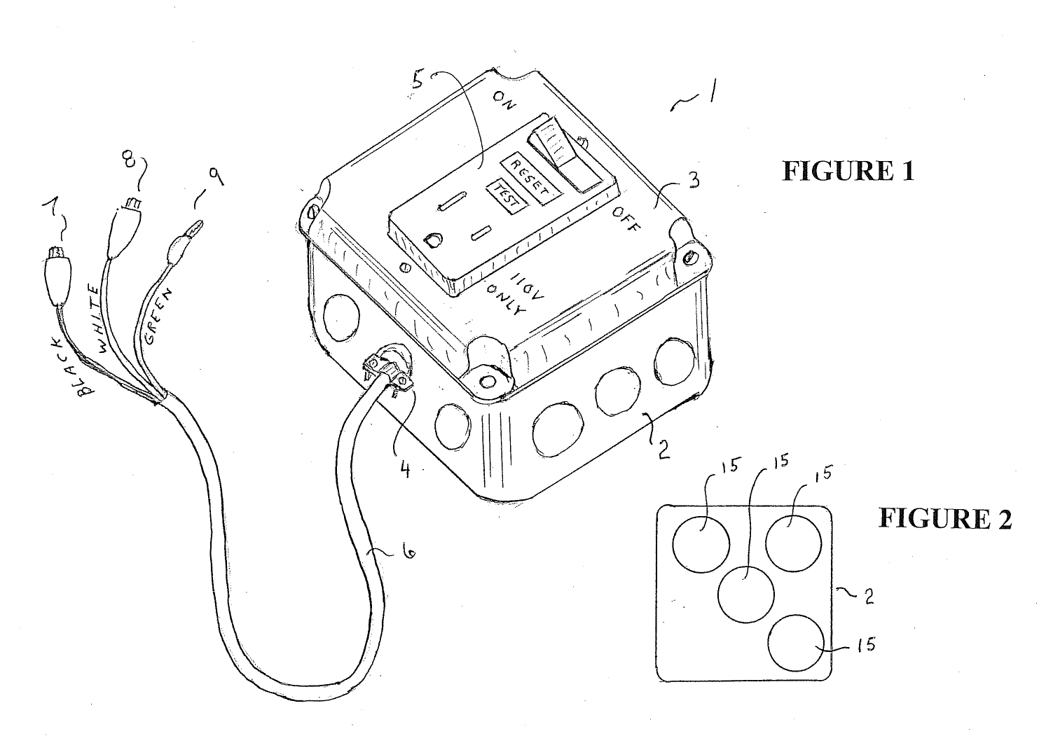

FIG. 1 shows the first embodiment of portable outlet box 1 of this invention. It can be seen that it is largely fabricated from readily available components such as housing 2 and top panel 3 which are a 4″ square metal electrical box and single duplex top panel respectively. A standard metal line cord strain relief 4 is also used. Line cord 6 is about four feet long and is stripped of outer covering for about 8″ revealing 3 pigtails with white, black, and green insulation. The black and white pigtails for the hot and neutral electrical connections are terminated in insulating boot-covered general purpose spring clip connectors. The green ground connection is made via a smaller boot-covered alligator clip. The GFI protected single AC outlet 5 with on/off switch is a single purchased module such as a LEVITON Pro Series Model 057. The normal recommended attachments to the terminals as per manufacturer's instructions are used.

FIG. 2 shows the back side with four adhesively attached round ceramic magnets. Other configurations of one or more magnets of appropriate strength can be used.

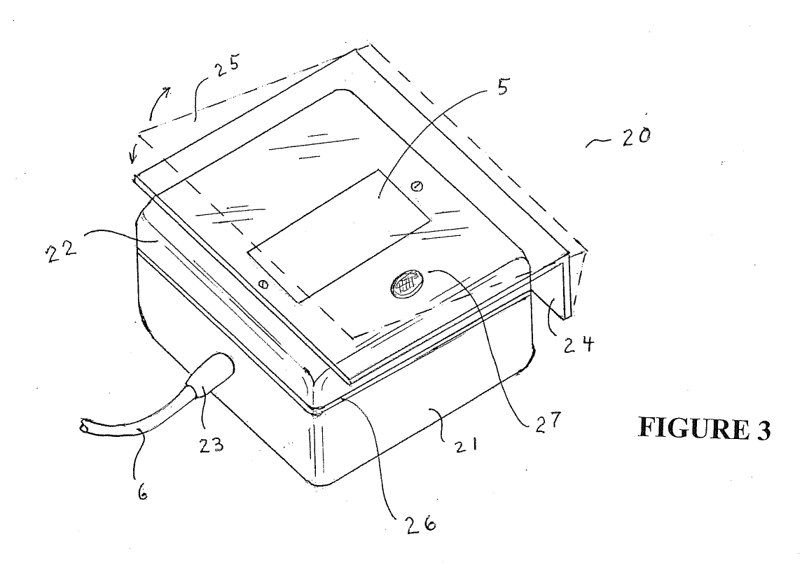

FIG. 3 shows the preferred embodiment of portable outlet box 20 which is preferably made of robust molded sections of ABS plastic with an elastomeric surface. Housing 21 and top panel 22 are screwed together from the bottom with gasket 26 between, while GFI/outlet 5 is sealed to top panel 22 with a gasket from the inside, all to afford water resistance. A small hydrophobic vent 27 is optionally used to insure that the interior remains dry long-term. Cord 6 is retained to housing 21 via waterproof strain relief 23. Optional panel 24, which is preferably a UV-resistant polycarbonate shield, swings (see 25) up out of the way on friction hinges attached to one side of housing 21; it protects a plug in the outlet from rain. Magnets on the back side of housing 21 are used for removable attachment.

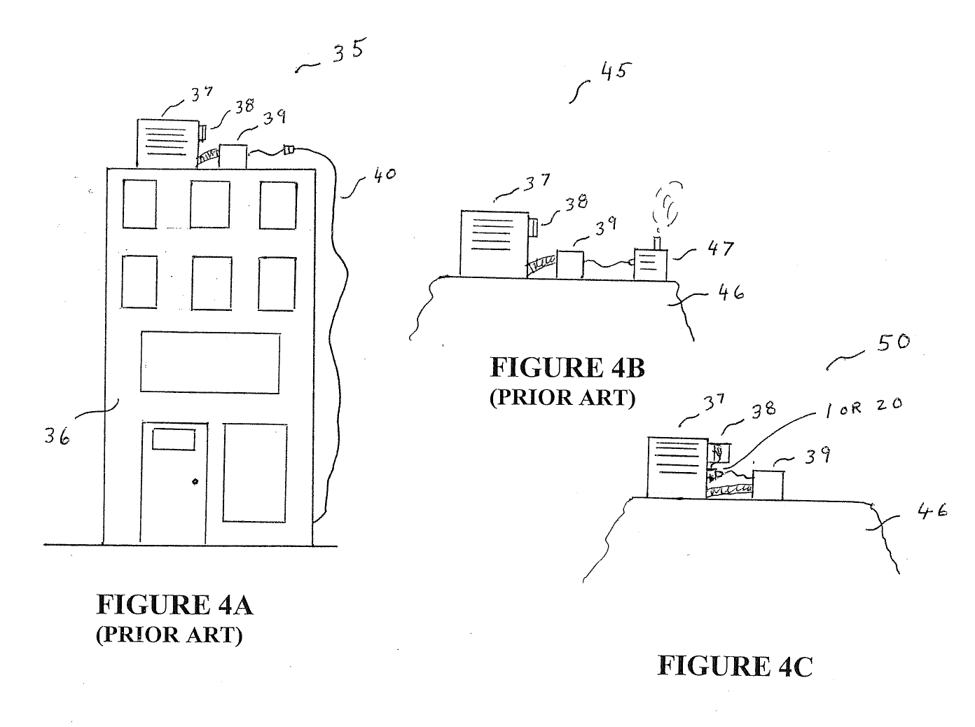

Prior art FIGS. 4A and 4B contrasts prior art methods used to service a rooftop AC unit that was empty of refrigerant with the method of FIG. 4C used with the portable outlet box of this invention. In prior art FIG. 4A a low-rise commercial building 36 is shown with AC unit 37 and attached electrical service panel 38. A vacuum pump 39 is used to vacuum out the refrigerant lines; it is plugged into long extension cord 40. If any of the windows or the roof stairwell are accessible and have an outlet, a much shorter extension cord than shown could be used, but service personnel usually carry cumbersome long cords for “worst-case” venues.

In prior art FIG. 4B a section of rooftop of a high-rise building is shown wherein outlet accessibility is not available. In this case, a portable generator 47 is used to supply electricity to run vacuum pump 39. This is a very cumbersome solution since the service upkeep of an engine-driven generator is high, the fuel is highly combustible, and the reliability is low. The generator is also a heavy item.

FIG. 4C shows the same rooftop section as in prior art FIG. 4B, but the compact and lightweight portable outlet box (1 or 20) of this invention is used. It could be carried in a toolbox. Service panel 38 is now opened to permit pigtails of cord 6 to be electrically clipped to the terminals and ground while box is magnetically attached to the housing of AC unit 37. Vacuum pump 39 is then simply plugged into outlet on box 1 or 20. Other air conditioner service that would benefit from this outlet box include running a recovery machine to recover existing refrigerant in the unit, and running a small pony pump to remove water in an attic-located emergency drain pan in a case of a residential air handler drain clog. Another example would be hooking the device up to an outside condenser on the exterior side of a house if there was no power outlet and the unit required a recovery machine or a vacuum pump. The outlet box of this invention can also be used in other venues or other service and/or construction work to supply power to hand tools, for drop lights, or for recharging tool batteries.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

I claim:

1. A method of servicing a remotely located electrically powered appliance comprising the steps of:
providing a portable AC outlet box comprising a housing having a top panel and a bottom panel, a GFI protected AC outlet with a reset switch mounted in said top panel, a line cord extending out through a wall of said housing, said line cord containing hot, neutral and ground connection lines;
opening a service panel of said appliance;
connecting said hot, neutral and ground connection lines in said power cord to corresponding electrical connections within said service panel; and
plugging into said outlet on said outlet box any electrical equipment required to service said appliance, thereby avoiding the use of lengthy electrical extension cords.

2. The method of claim 1 in which said power cord terminates in three exposed insulated pigtails, two of said pigtails being for said hot and neutral electrical connections, and the third pigtail being for said ground connection, the insulation on said pigtails being color coded, and said pigtails terminating in insulation covered alligator clips.

3. The method of claim 2 in which magnets are mounted on said bottom panel to permit said outlet box to be mounted on any ferromagnetic surface.

4. The method of claim 3 in which said housing is of metal construction.

5. The method of claim 3 in which said housing of said outlet box is of ABS plastic with an elastomeric surface, said outlet being sealed to said top panel with a gasket to afford water resistance.

6. The method of claim 5 wherein said outlet box has a hinged UV-resistant polycarbonate shield mounted with friction hinges to protect said outlet from rain.

7. A portable AC outlet box comprising:
a housing having a top panel and a bottom panel;
a GFI protected AC outlet with a reset switch mounted in said top panel;
a line cord extending out through a wall of said housing;
said line cord terminating in three insulated pigtails, two of said pigtails being for hot and neutral electrical connections, and the third pigtail being for a ground connection;
the insulation on said pigtails being color coded; and
said pigtails terminating in insulation covered alligator clips.

8. The outlet box of claim 7 in which magnets are mounted on said bottom panel to permit said outlet box to be mounted on any ferromagnetic surface.

9. The outlet box of claim 8 in which said housing is of metal construction.

10. The outlet box of claim 8 in which said housing is of ABS plastic with an elastomeric surface, said outlet being sealed to said top panel with a gasket to afford water resistance.

11. The outlet box of claim 10 having a hinged UV-resistant polycarbonate shield mounted with friction hinges to protect said outlet from rain.
